(19) United States
(12) Patent Application Publication
(10) Pub. No.: US 2023/0306997 A1
(43) Pub. Date: Sep. 28, 2023

(54) MAGNETIC DISK DEVICE AND METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Fuyuki TAWADA, Kawasaki Kanagawa (JP)

(21) Appl. No.: 17/931,647

(22) Filed: Sep. 13, 2022

(30) Foreign Application Priority Data
Mar. 24, 2022 (JP) 2022-048352

(51) Int. Cl. G11B 19/04; G11B 20/18

(52) U.S. Cl. CPC G11B 19/041; G11B 20/1879; G11B 20/1883

(57) ABSTRACT

According to an embodiment, a magnetic disk is provided with a track, and the track is provided with a data sector. The data sector includes a plurality of servo regions in which servo data is written, and a plurality of first data regions. Each of the plurality of first data regions is disposed between two servo regions of the plurality of servo regions. The controller executes a first write operation of writing data sequentially to the plurality of first data regions using the magnetic head. After the first write operation, the controller executes a second write operation of retrying the writing to a second data region in which the write error is detected among the plurality of first data regions, and not retrying the writing to a third data region in which the write error is not detected among the plurality of first data regions.

### CROSS-REFERENCE TO RELATED APPLICATIONS

This application is based upon and claims the benefit of priority from Japanese Patent Application No. 2022-048352, filed on Mar. 24, 2022; the entire contents of which are incorporated herein by reference.

### FIELD

Embodiments described herein relate generally to a magnetic disk device and a method.

### BACKGROUND

In recent years, regarding a magnetic disk device, a distance between tracks tends to be reduced with an increase in recording density. Therefore, the influence on adjacent tracks at the time of writing is relatively increased. The influence on the adjacent tracks includes, for example, adjacent track interference (ATI) or overwriting to data of the adjacent tracks. In a case where the influence on the adjacent tracks exceeds a certain level, it is difficult to read data written to the adjacent tracks.

### BRIEF DESCRIPTION OF THE DRAWINGS

FIG. 1 is a schematic diagram illustrating an example of a configuration of a magnetic disk device of an embodiment;

FIG. 2 is a diagram illustrating an example of a configuration of a magnetic disk of the embodiment;

FIG. 3 is an enlarged view of a part of one track of the embodiment;

FIG. 4 is a schematic diagram for describing a first unit write operation of the embodiment executed without detecting a write error;

FIG. 5 is a schematic diagram for describing the first unit write operation of the embodiment in which a write error is detected during execution;

FIG. 6 is a schematic diagram for describing a second unit write operation of the embodiment after the first unit write operation illustrated in FIG. 5;

FIG. 7 is a schematic diagram for describing a third unit write operation of the embodiment after the second unit write operation illustrated in FIG. 6; and

FIG. 8 is a flowchart illustrating an example of details of a write operation of a controller of the embodiment.

### DETAILED DESCRIPTION

According to an embodiment, a magnetic disk device includes a magnetic disk, a magnetic head, and a controller. The magnetic disk is provided with a track, and the track is provided with a data sector. The data sector includes a plurality of servo regions in which servo data is written, and a plurality of first data regions. Each of the plurality of first data regions is disposed between two servo regions of the plurality of servo regions. The controller executes a first write operation of writing data sequentially to the plurality of first data regions using the magnetic head. After the first write operation, the controller executes a second write operation of retrying the writing to a second data region in which the write error is detected among the plurality of first data regions, and not retrying the writing to a third data region in which the write error is not detected among the plurality of first data regions.

The magnetic disk device and the method according to the embodiment will be described below in detail with reference to the accompanying drawings. In addition, the present invention is not limited by this embodiment.

### Embodiment

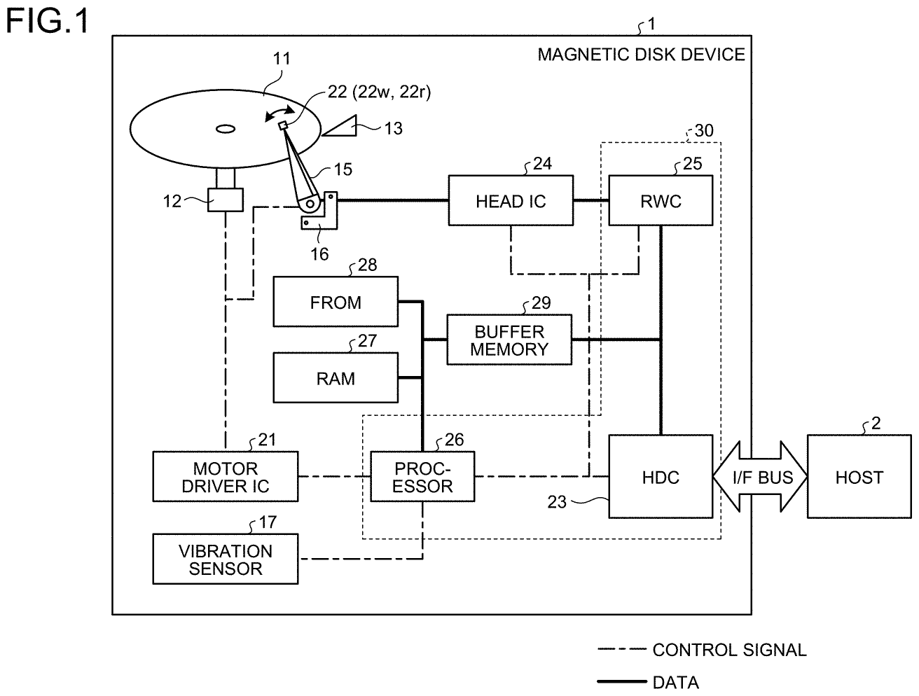

FIG. 1 is a schematic diagram illustrating an example of a configuration of a magnetic disk device 1 of an embodiment.

The magnetic disk device 1 is connected to a host 2. The magnetic disk device 1 can receive access commands such as write commands and read commands from the host 2.

The magnetic disk device 1 includes a magnetic disk 11 with a magnetic layer formed on a surface of the magnetic disk 11. The magnetic disk device 1 writes data to the magnetic disk 11 or reads data from the magnetic disk 11 according to the access command.

Data is written or read via a magnetic head 22. In addition to the magnetic disk 11, the magnetic disk device 1 includes a spindle motor 12, a lamp 13, an actuator arm 15, a voice coil motor (VCM) 16, a vibration sensor 17, a motor driver integrated circuit (IC) 21, the magnetic head 22, a hard disk controller (HDC) 23, a head IC 24, a read/write channel (RWC) 25, a processor 26, a RAM 27, a flash read only memory (FROM) 28, and a buffer memory 29.

The magnetic disk 11 is rotated at a predetermined rotation speed by the spindle motor 12 mounted coaxially. The spindle motor 12 is driven by the motor driver IC 21.

The processor 26 controls the rotation of the spindle motor 12 and the rotation of the VCM 16 via the motor driver IC 21.

The magnetic head 22 writes and reads information to and from the magnetic disk 11 by a write core 22w and a read core 22r provided therein. The magnetic head 22 is attached to the tip of the actuator arm 15. The magnetic head 22 is moved in a radial direction of the magnetic disk 11 by the VCM 16. Note that a plurality of one or both of the write cores 22w and the read cores 22r provided in the magnetic head 22 may be provided for a single magnetic head 22.

In a case where the rotation of the magnetic disk 11 is stopped or the like, the magnetic head 22 is moved onto the lamp 13. The lamp 13 is configured to hold the magnetic head 22 at a position separated from the magnetic disk 11.

At the time of the read operation, the head IC 24 amplifies and outputs a signal read from the magnetic disk 11 by the magnetic head 22, and supplies the signal to the RWC 25. Further, at the time of the write operation, the head IC 24 amplifies the signal corresponding to the data to be written supplied from the RWC 25, and supplies the signal to the magnetic head 22.

The HDC 23 performs control of transmission and reception of data with the host 2 via an I/F bus, control of the buffer memory 29, and the like.

The buffer memory 29 is used as a buffer for data transmitted to and received to and from the host 2. For example, the buffer memory 29 is used for temporarily storing data to be written or data read from the magnetic disk 11.

The buffer memory 29 is configured by a volatile memory capable of high-speed operation. The type of the memory configuring the buffer memory 29 is not limited to a specific type. The buffer memory 29 can be configured by, for example, a dynamic random access memory (DRAM), a static random access memory (SRAM), or a combination thereof. The buffer memory 29 may be configured by an arbitrary non-volatile memory.

The RWC 25 performs modulation such as error correction coding on the data to be written supplied from the HDC 23, and supplies the modulated data to the head IC 24. The RWC 25 performs demodulation including an error correction process for the signal, which is read from the magnetic disk 11 and is supplied from the head IC 24, and outputs the demodulated signal as digital data to the HDC 23.

The processor 26 is a central processing unit (CPU), for example. The vibration sensor 17, the RAM 27, the flash read only memory (FROM) 28, and the buffer memory 29 are connected to the processor 26.

The FROM 28 is a non-volatile memory. The FROM 28 stores firmware (program data) and various operating parameters. The firmware may be stored in the magnetic disk 11.

The RAM 27 is configured by, for example, a DRAM, an SRAM, or a combination thereof. The RAM 27 is used as an operation memory by the processor 26. The RAM 27 is used as an area in which firmware is loaded and an area in which various types of management data are temporarily stored.

The processor 26 performs overall control of the magnetic disk device 1 according to firmware stored in the FROM 28 or the magnetic disk 11. For example, the processor 26 loads the firmware from the FROM 28 or the magnetic disk 11 to the RAM 27, and executes control of the motor driver IC 21, the head IC 24, the RWC 25, the HDC 23, and the like according to the loaded firmware.

The vibration sensor 17 can detect the amount of vibration in multiple directions. The amount of vibration detected by the vibration sensor 17 is displacement, speed, acceleration, or any other physical quantity. The processor 26 acquires a detection value from the vibration sensor 17 in a predetermined short cycle while writing data to the magnetic disk 11, and uses the acquired detection value for determining whether a write error has occurred. Details of the write error will be described later.

The configuration including the HDC 23, the RWC 25, and the processor 26 can be regarded as a controller 30 that controls the operation of the magnetic disk device 1. In addition to those components, the controller 30 may include other components (for example, RAM 27, FROM 28, or buffer memory 29).

The firmware program may be stored in the magnetic disk 11. Some or all of the functions of the processor 26 may be realized by a hardware circuit such as a field-programmable gate array (FPGA) or an application specific integrated circuit (ASIC).

The number of magnetic disks 11 included in the magnetic disk device 1 is not limited to one. Further, the magnetic disk device 1 may include actuator arms 15 and magnetic heads 22 in a number corresponding to the number of magnetic disks 11. In addition, in a case where the magnetic disk device 1 includes a plurality of magnetic heads 22, the plurality of magnetic heads 22 may be integrally moved, or the plurality of magnetic heads 22 may constitute a plurality of groups that can be independently moved.

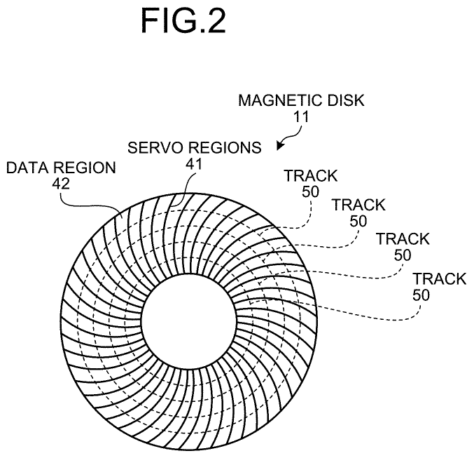

FIG. 2 is a diagram illustrating an example of a configuration of the magnetic disk 11 of the embodiment. servo data used for positioning the magnetic head 22 is written to the magnetic layer formed on the surface of the magnetic disk 11 by, for example, a servo writer or by self-servo writing (SSW).

FIG. 2 illustrates servo regions 41 radially arranged as an example of arrangement of the servo regions in which the servo data is written. In the circumferential direction, a portion between two servo regions 41 is a data region 42 in which data can be written. A plurality of concentric tracks (for example, tracks 50 in FIG. 2) are set in the radial direction of the magnetic disk 11. The region delimited by the servo region 41 on the track 50 is also referred to as the servo sector.

The servo data includes a servo mark, a gray code, a burst pattern, and a post code. The servo mark indicates the start of servo data. The gray code includes an ID for identifying each track 50 provided in the magnetic disk 11, that is, a track number, and an ID for identifying each servo sector (that is, the servo region 41) on the track 50, that is, a servo sector number. The burst pattern is data used to detect the amount of misalignment of the track indicated by the track number included in the gray code from the center. The track number included in the gray code is given as an integer value, for example, and it is possible to obtain an offset amount after the decimal point based on the position indicated by the track number by demodulating the burst pattern. That is, the current position of the magnetic head 22 in the radial direction is obtained by demodulating the burst pattern. The post code is data for correcting misalignment of the shape of the track 50 defined by the gray code and the burst pattern, from the ideal shape of the track 50.

In a case where data is written to the magnetic disk 11 or data is read from the magnetic disk 11, the controller 30 executes positioning of the magnetic head 22, that is, seek control and tracking control, on the basis of the servo data read from the servo region 41 by the magnetic head 22.

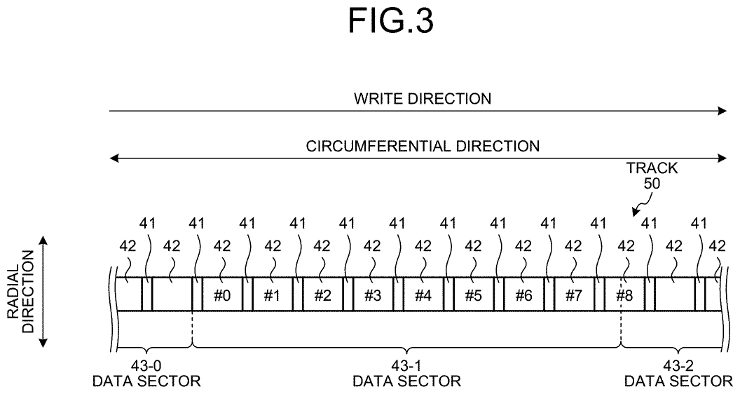

FIG. 3 is an enlarged view of a part of one track 50 of the embodiment. FIG. 3 illustrates a write direction, that is, a direction in which the magnetic head 22 is moved relative to the track 50 during the write operation. The write direction is a direction opposite to a rotation direction of the magnetic disk 11.

The track 50 is provided with a plurality of data sectors 43. Data with a common size is subjected to error correction coding and is written to each of the plurality of data sectors 43. The common size is referred to as a sector size.

Each data sector 43 includes a plurality of data regions 42 as the regions to which the data is written. That is, the data with the sector size is divided into a plurality of data pieces, and each of the plurality of data pieces is written to each data region 42. The head and tail of each data sector 43 may or may not be aligned at the boundary of the data region 42.

FIG. 3 illustrates three data sectors 43-0, 43-1, and 43-2 as the plurality of data sectors 43. FIG. 3 illustrates a part of the tail of the data sector 43-0, the data sector 43-1 from the head to the tail, and a part of the head of the data sector 43-2.

The head is a portion where the magnetic head 22 first reaches when the magnetic disk 11 makes one rotation. The tail is a portion where the magnetic head 22 reaches last when the magnetic disk 11 makes one rotation.

According to the example illustrated in FIG. 3, each data sector 43 is divided into a plurality of data regions 42 by a plurality of servo regions 41. For example, the data sector 43-1 includes, from the head thereof, eight complete data regions 42 and about half the data region 42.

As described above, each data region 42 is provided between the two servo regions 41. Accordingly, each data sector 43 includes a plurality of servo regions 41, and a plurality of data regions 42.

Hereinafter, the data sector 43-1 among the plurality of data sectors 43 will be described as an example. In the present specification, each of the eight and approximately half data regions 42 included in the data sector 43-1 is identified by being numbered sequentially from the head. That is, the description will be given on the assumption that the data sector 43-1 includes a data region #0, a data region #1, a data region #2, a data region #3, a data region #4, a data region #5, a data region #6, a data region #7, and a part of a data region #8 from the head.

Next, a write error will be described. The write error refers to a state in which it is difficult to write the data to be written such that the data to be written and the data of the adjacent track 50 can be read later. In a state where a write error has occurred (more precisely, a state where a write error has occurred and has been detected by the controller 30), writing is prohibited.

For example, the write error includes off-track. The off-track refers to a state where the position of the magnetic head 22 in the radial direction is shifted from the center of the target track 50, that is, the write destination track 50 of the data. In a case where off-track occurs while data (referred to as first data) is written to a certain track 50 (referred to as a first track 50), the first data is written to a position where the first data protrudes to the track 50 (referred to as a second track 50) adjacent to the first track 50. As a result, the first data is overwritten on the data (referred to as second data) already written in the second track 50, or the second data is strongly affected by the ATI caused by the writing of the first data, so that the reading of the second data may be difficult. Further, in a case where new data (referred to as third data) is written to the second track 50 later, the third data is overwritten on the first data protruding to the second track 50 due to the off-track, so that the reading of the first data may be difficult. Thus, in a case where the off-track is detected, the controller 30 interrupts writing.

In order to detect the off-track, the controller 30 compares, for example, the amount of misalignment of the magnetic head 22 from the center of the target track 50 with a preset threshold value (referred to as a first threshold value). In a case where the amount of misalignment exceeds the first threshold value, the controller 30 determines that off-track has occurred. In a case where the amount of misalignment is less than the first threshold value, the controller 30 determines that no off-track has occurred.

The determination as to whether off-track has occurred is made on the basis of the servo data. Thus, at the timing when the magnetic head 22 reads the servo data from the servo region 41, the controller 30 determines whether off-track has occurred on the basis of the read servo data. The method of detecting off-track is not limited to the above example.

In addition, the write error includes application of large vibration to the magnetic disk device 1 during the write operation. In the present specification, vibration includes an impact. In a case where vibration is applied to the magnetic disk device 1 from the outside, it becomes difficult to perform writing without causing off-track. Therefore, the controller 30 interrupts the writing in a case where vibration of an allowable level or more is detected.

For example, the controller 30 sequentially acquires the detection value by the vibration sensor 17 at a very short predetermined cycle, and compares the detection value with the preset threshold value (referred to as a second threshold value) every time the detection value is acquired. In a case where the detection value exceeds the second threshold value, the controller 30 determines that large vibration is applied from the outside. In a case where the detection value is less than the second threshold value, the controller 30 determines that no large vibration is applied from the outside. The method of detecting vibration of the allowable level or more is not limited to this example.

The write error may include various events other than occurrence of off-track and reception of vibration. In the present specification, the controller 30 considers that the occurrence of off-track and the reception of vibration are write errors.

In a case where the write error is detected, the controller 30 interrupts the write operation, and retries the write operation later. The retried write operation is referred to as a write retry operation.

Here, a technique to be compared with the embodiment will be described. A technique to be compared with the embodiment will be referred to as a comparative example. According to the comparative example, in a case where a write error is detected while data is written to a certain data sector, the magnetic disk device executes the write retry operation on all the data regions constituting the data sector.

According to the comparative example, since the write retry operation is executed in units of data sectors, the execution period of the write retry operation is long. Thus, there is a possibility that a write error occurs again in the execution period of the write retry operation. In a case where a write error is detected again in the execution period of the write retry operation, the write retry operation is further executed. Therefore, there is a possibility that the writing cannot be completed to the end.

According to the comparative example, since the writing is executed by the write retry operation also on the data region where the writing has been completed without detecting the write error, the number of times of the writing per data region is large. Therefore, the influence of the ATI on the adjacent track is large.

According to the comparative example, since the number of times of the writing per data region is large, there is a high possibility that off-track occurs accordingly, and there is a high possibility that the adjacent track is affected by the off-track.

That is, according to the comparative example, the influence on the adjacent track is large.

In the embodiment, the magnetic disk device 1 is configured to retry the write operation not in units of data sectors 43 but in units of data regions 42 smaller than the data sectors 43. Therefore, the possibility that the write error occurs again in the execution period of the write retry operation is suppressed. Since the writing of the data by the write retry operation is not executed on the data region 42 in which the writing has been completed without detecting the write error, the number of write operations per data region 42 is suppressed. As a result, the influence of the ATI on the adjacent track 50 can be suppressed. In addition, the possibility of the occurrence of the off-track is suppressed, and the possibility that the adjacent track 50 is affected by the off-track is suppressed. That is, the influence on the adjacent track 50 is suppressed.

Hereinafter, the operation of writing data of a sector size to one data sector 43 is referred to as a first unit write operation. The write retry operation executed on all the data regions 42 in which the write error is detected in the first unit write operation is referred to as a second unit write operation. The write retry operation executed on all the data regions 42 in which the write error is detected in the second unit write operation is referred to as a third unit write operation. Each unit write operation is executed while the magnetic disk 11 makes one rotation.

The first unit write operation is an example of the first write operation. The second unit write operation and the third unit write operation are examples of the second write operation.

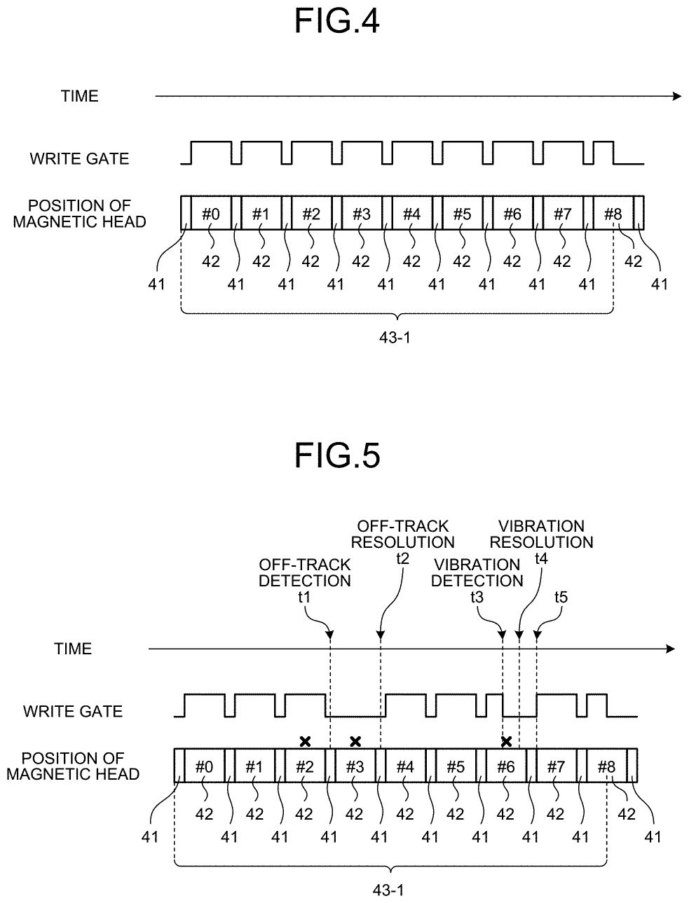

The first unit write operation, the second unit write operation, and the third unit write operation of the magnetic disk device 1 according to the embodiment will be described with reference to FIGS. 4 to 7.

FIG. 4 is a schematic diagram for describing a first unit write operation of the embodiment executed without detecting a write error. In FIG. 4, the waveform of a write gate signal (hereinafter, referred to as a write gate) and the transition of the position of the magnetic head 22 are illustrated.

The write gate is a signal transmitted from the HDC 23 to the RWC 25, and is a signal indicating a period in which writing of data is allowed. In the example illustrated in FIG. 4, a case where the write gate is at the “H” level indicates that writing of data is allowed, and a case where the write gate is at the “L” level indicates that writing of data is not allowed. In a period in which the magnetic head 22 passes through the servo region 41, the write gate is maintained at the “L” level, and thereby the servo data of the servo region 41 is prevented from being overwritten with other data.

In the first unit write operation, when no write error is detected, the HDC 23 maintains the write gate at the “H” level in a period in which the magnetic head 22 passes through each data region 42 as illustrated in FIG. 4. As a result, data is written to each data region 42.

FIG. 5 is a schematic diagram for describing the first unit write operation of the embodiment in which a write error is detected during execution.

In the example illustrated in FIG. 5, no write error is detected until time t1 at which the magnetic head 22 passes through the servo region 41 provided between the data region #2 and the data region #3, and data is written to each data region 42 through which the magnetic head 22 passes, similarly to the example illustrated in FIG. 4.

At time t1, the controller 30 (for example, processor 26) detects off-track on the basis of the servo data read from the servo region 41 provided between the data region #2 and the data region #3. In a case where off-track is detected at time t1, the HDC 23 maintains the write gate at “L” in a period in which the magnetic head 22 passes through the data region 42 (here, the data region #3) immediately after the off-track. Therefore, the controller 30 interrupts writing to the data sector 43-1 at the head of the data region #3.

At time t2 when the magnetic head 22 passes through the servo region 41 subsequent to the data region #3 in the write direction, the controller 30 (for example, the processor 26) detects that the off-track has been resolved on the basis of the servo data read from the servo region 41. Then, the HDC 23 maintains the write gate at “H” in a period in which the magnetic head 22 passes through the data region 42 (here, the data region #4). Therefore, the controller 30 restarts writing to the data sector 43-1 from the head of the data region #4.

In a period in which the magnetic head 22 passes through the data region #4 and the data region #5, data is written without a write error being detected.

At time t3 of a period in which the magnetic head 22 passes through the data region #6, the controller 30 detects vibration (more precisely, that the detection value by the vibration sensor 17 exceeds the second threshold value) on the basis of the detection value of the vibration sensor 17. When the vibration is detected at time t3, the HDC 23 immediately causes the write gate to transition from the “H” level to the “L” level. Thereafter, at time t4, the controller 30 detects that the vibration has been resolved (more precisely, the detection value by the vibration sensor 17 has fallen below the second threshold value). The HDC 23 returns the write gate to “H” from time t5 when the magnetic head 22 passes through the head of the data region 42 (that is, the data region #7) to be approached next by the magnetic head 22. Therefore, the controller 30 restarts writing to the data sector 43-1 from the head of the data region #7.

In a period in which the magnetic head 22 passes through the data region #7 and a part of the data region #8 included in the data sector 43-1, data is written without a write error being detected, and the first unit write operation is ended.

As described above, in the first unit write operation, in a case where it is determined that a write error has occurred, the controller 30 interrupts writing during the execution of the first unit write operation. Then, after the writing is interrupted, in a case where it is determined that the write error has been resolved before the magnetic head 22 reaches the data region #8 at the tail of the data sector 43, the writing is restarted before the magnetic head 22 reaches the data region #8 at the tail of the data sector 43.

In the first unit write operation illustrated in FIG. 5, a write error occurs at the time of the writing to some data regions 42. The controller 30 selects the data region 42 as a write target in the second unit write operation on the basis of the determination on whether a write error has occurred at the time of the writing to each data region 42 in the first unit write operation.

For example, the controller 30 sets the data regions #3 and #6 in which writing has been interrupted or has not been performed due to the write error, as write targets in the second unit write operation.

In addition, in the example illustrated in FIG. 5, off-track is detected when the magnetic head 22 passes through the servo region 41 provided between the data region #2 and the data region #3. The off-track is detected as the magnetic head 22 passes through the servo region 41. Thus, it can be estimated that there is a high possibility that the off-track has actually occurred from the time of the writing immediately before the off-track is detected, that is, from the time of the writing on the data region #2. Therefore, the controller 30 also sets the data region #2 as the write target in the second unit write operation in addition to the data regions #3 and #6. The controller 30 does not set the other data regions #0, #1, #4, #5, #7, and #8 as the write targets.

In a case where the magnetic disk 11 is rotated after the first unit write operation and the magnetic head 22 has approached the data sector 43-1 again, the controller 30 starts the second unit write operation with the data regions #2, #3, and #6 as the write targets.

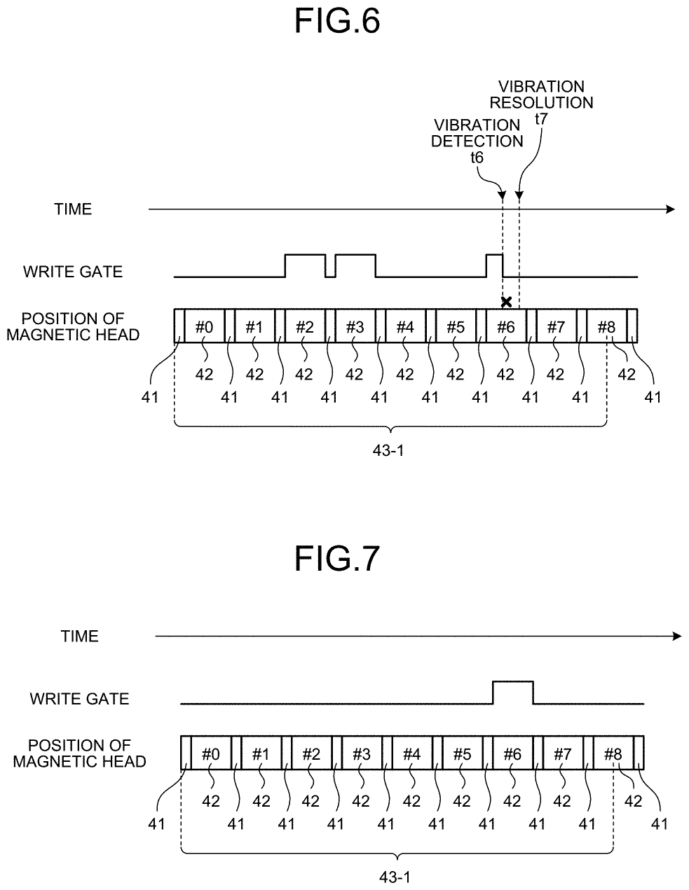

FIG. 6 is a schematic diagram for describing a second unit write operation of the embodiment after the first unit write operation illustrated in FIG. 5.

In the second unit write operation, the HDC 23 maintains the write gate at “H” in a period in which the magnetic head 22 passes through the data region 42 as the write target, and maintains the write gate at “L” in a period in which the magnetic head 22 passes through the data region 42 which is not the write target. Therefore, in the second unit write operation, data is written only to the data region 42 set as the write target.

In the example illustrated in FIG. 6, writing is completed for the data regions #2 and #3 among the data regions #2, #3, and #6 that are the write targets, without a write error being detected. However, at the time of the writing to the data region #6, vibration is detected again (time t6). When the vibration is detected at time t6, the HDC 23 immediately causes the write gate to transition from the “H” level to the “L” level. Thereafter, although it is detected that the vibration is resolved at time t7, the HDC 23 maintains the write gate at “L” until the magnetic head 22 reaches the tail of the data region #6. The magnetic head 22 passes through all of the data regions #2, #3, and #6 set as the write targets, and the second unit write operation is ended.

At the time when the second unit write operation is ended, the data writing is not completed only for the data region #6 among the data regions 42 constituting the data sector 43-1, due to the write error. Therefore, the controller 30 sets the data region #6 as the write target. Then, in a case where the magnetic disk 11 is rotated after the second unit write operation and the magnetic head 22 has approached the data sector 43-1 again, the controller 30 starts the third unit write operation with the data region #6 as the write target.

FIG. 7 is a schematic diagram for describing a third unit write operation of the embodiment after the second unit write operation illustrated in FIG. 6.

In the third unit write operation, similarly to the second unit write operation, the HDC 23 maintains the write gate at “H” in a period in which the magnetic head 22 passes through the data region 42 as the write target, and maintains the write gate at “L” in a period in which the magnetic head 22 passes through the data region 42 which is not the write target. Therefore, in the third unit write operation, data is written only to the data region 42 set as the write target.

In the example illustrated in FIG. 7, writing is completed for the data region #6 as the write target, without a write error being detected. By the first unit write operation to the third unit write operation, data can be written to all the data regions 42 constituting the data sector 43-1 without a write error being detected, and thus the writing to the data sector 43-1 is ended.

In a case where a write error occurs also in the third unit write operation, a write retry operation similar to the third unit write operation is executed.

Next, details of the operation of the controller 30 for realizing the operation described with reference to FIGS. 4 to 7 will be described.

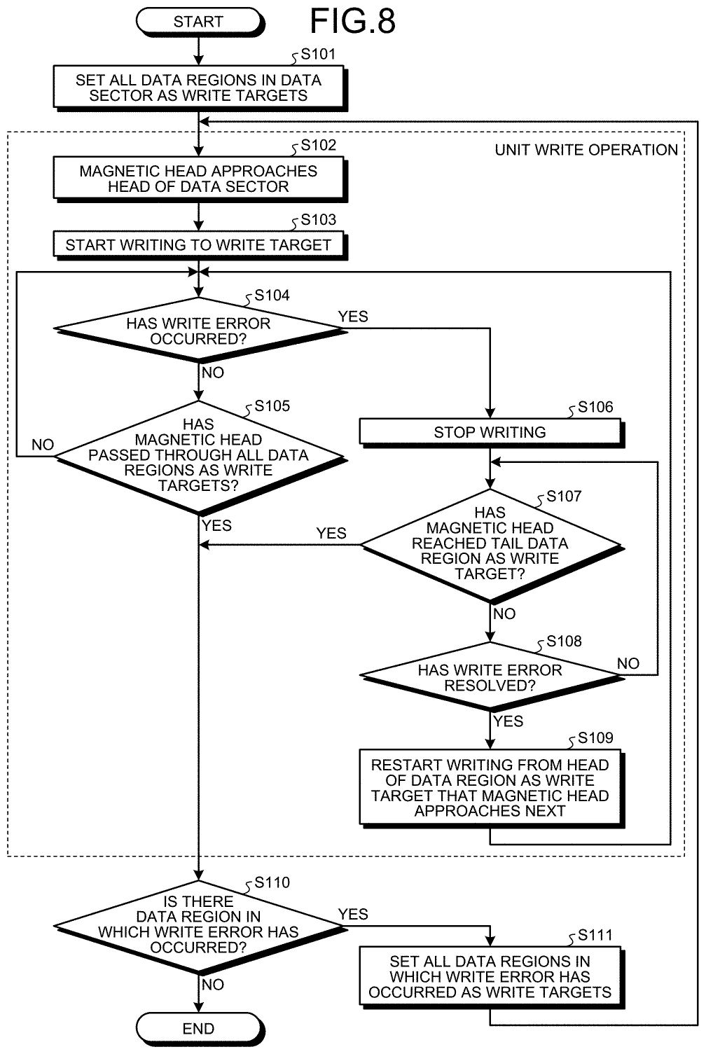

FIG. 8 is a flowchart illustrating an example of details of the write operation of the controller 30 of the embodiment.

First, the controller 30 sets all the data regions in the data sector 43 as the write targets (S101), and performs seek control and tracking control. Then, when the magnetic head 22 approaches the head of the data sector 43 as the write destination (S102), the controller 30 starts writing to the write target (S103).

The controller 30 determines whether a write error has occurred during the execution of writing (S104).

In a case where it is determined that a write error has not occurred (S104: No), that is, in a case where a write error has not been detected, the controller 30 determines whether the magnetic head 22 has passed through all the data regions 42 as the write targets (S105).

In a case where it is determined that a write error has occurred (S104: Yes), that is, in a case where a write error is detected, the controller 30 sets the write gate to “L” to stop the writing (S106), and determines whether the magnetic head 22 has reached the tail data region 42 among the data regions 42 as the write target (S107).

In a case where it is determined that the magnetic head 22 has not reached the tail data region 42 (S107: No), the controller 30 determines whether the write error has been resolved (S108).

In a case where it is determined that the write error has not been resolved (S108: No), the control transits to S107, and the controller 30 executes the determination process of S107 again.

In a case where it is determined that the write error has been resolved (S108: Yes), the controller 30 restarts the writing from the head of the data region 42 as the write target that the magnetic head 22 approaches next (S109). Then, the control proceeds to S104.

A series of processes in S102 to S109 is executed in a period in which the magnetic disk 11 makes one rotation. The series of processes in S102 to S109 constitutes the unit write operation. That is, the series of processes of S102 to S109 executed for the first time after S101 corresponds to the first unit write operation, the series of processes of S102 to S109 executed for the second time corresponds to the second unit write operation, and the series of processes of S102 to S109 executed for the third time corresponds to the third unit write operation.

In a case where it is determined that the magnetic head 22 has passed through all the data regions 42 as the write targets (S105: Yes), or in a case where it is determined that the magnetic head 22 has reached the tail data region 42 among the data regions 42 as the write targets (S107: Yes), the unit write operation is ended. Then, the controller 30 determines whether there is a data region 42 in which a write error has occurred in the unit write operation executed last (S110).

In S110, the controller 30 regards not only the data region 42 in which the write error is detected during the unit write operation but also the data region 42 in which it is assumed that the write error has occurred, as the data region 42 in which the write error has occurred. For example, in the case illustrated in FIG. 5, during the first unit write operation, a write error is not detected at the time of writing to the data region #2. However, a write error (more precisely, off-track) is detected by the servo data read from the servo region 41 subsequent to the data region #2. Therefore, it can be estimated that off-track has already occurred at the time of the writing to the data region #2. In a case where the controller 30 reads servo data from a certain servo region 41 and detects off-track on the basis of the servo data, it is considered that off-track has occurred in two data regions 42 adjacent before and after the servo region 41.

In a case where there is a data region 42 in which a write error has occurred (S110: Yes), the controller 30 sets all the data region in which the write error has occurred as the write targets of the next unit write operation (S111). Then, the control transits to S102, and the next unit write operation is started.

In a case where there is no data region 42 in which a write error has occurred (S110: No), the write operation of the embodiment is ended.

As described above, according to the embodiment, the controller 30 executes the first unit write operation of writing data sequentially to the data regions 42 in the data sector 43 using the magnetic head. After the first unit write operation, the controller 30 executes the second unit write operation of retrying the writing to the data region 42 in which the write error is detected among the data regions 42 in the data sector 43, and not retrying the writing to the data region 42 in which no write error is detected among the data regions 42 in the data sector 43.

Since the controller 30 is configured to retry the write operation not in units of data sectors 43 but in units of data regions 42 smaller than the data sector 43, the possibility that the write error occurs again during the execution period of the write retry operation is suppressed. Since the writing of the data by the write retry operation is not executed on the data region 42 in which the writing has been completed without detecting the write error, the number of write operations per data region 42 is suppressed. As a result, the influence of the ATI on the adjacent track 50 can be suppressed. In addition, the possibility of the occurrence of the off-track is suppressed, and the possibility that the adjacent track 50 is affected by the off-track is suppressed. That is, the influence on the adjacent track 50 is suppressed.

In addition, according to the embodiment, the controller 30 determines whether a write error has occurred during the execution of the first unit write operation, and interrupts the writing during the execution of the first unit write operation in a case where it is determined that a write error has occurred. After the writing is interrupted, in a case where the write error has been resolved before the magnetic head 22 reaches the data region 42 at the tail of the data sector 43, the controller 30 restarts the writing before the magnetic head 22 reaches the tail data region 42.

Since the writing is executed without wasting a time after the write error is resolved in each unit write operation, the total time required for the write operation can be shortened.

According to the embodiment, the write error includes off-track. The controller 30 reads servo data from the servo region 41 every time the magnetic head 22 passes through the servo region 41, and positions the magnetic head 22 using the read servo data. In addition, the controller 30 determines, every time the servo data is read, whether off-track has occurred on the basis of the read servo data.

According to the embodiment, in a case where it is determined that off-track has occurred on the basis of the servo data read from a certain servo region 41, it is determined that off-track has occurred in each of two data regions 42 adjacent to the servo region 41.

Therefore, it is possible to detect off-track occurring in the data region 42 on the basis of the servo data read from each servo region 41.

In addition, according to the embodiment, the controller 30 detects that the detection value by the vibration sensor 17 exceeds the threshold value, as a write error.

Therefore, in a situation where large vibration is applied from the outside so that off-track may occur, it is possible to interrupt the writing and protect the data of the adjacent tracks 50.

What is claimed is:

1. A magnetic disk device comprising:
a magnetic disk provided with a track, the track being provided with a data sector, the data sector including a plurality of servo regions in which servo data is written, and a plurality of first data regions, each of the plurality of first data region being arranged between two servo regions among the plurality of servo regions;
a magnetic head; and
a controller configured to execute a first write operation of writing data sequentially to the plurality of first data regions using the magnetic head, and execute, after the first write operation, a second write operation of retrying writing to a second data region in which a write error is detected among the plurality of first data regions, and not retrying writing to a third data region in which the write error is not detected among the plurality of first data regions.

2. The magnetic disk device according to claim 1, wherein
the controller is configured to
determine whether the write error has occurred during execution of the first write operation,
interrupt writing during the execution of the first write operation in a case where it is determined that the write error has occurred, and
restart writing before the magnetic head reaches a fourth data region at a tail of the data sector among the plurality of first data regions in a case where the write error has been resolved before the magnetic head reaches the fourth data region after interrupting the writing.

3. The magnetic disk device according to claim 1, wherein
the write error includes off-track, and
the controller is configured to
position the magnetic head based on the read servo data obtained by reading the servo data from each of the plurality of servo regions through which the magnetic head passes, and
determine, every time the servo data is read, whether the off-track has occurred based on the read servo data.

4. The magnetic disk device according to claim 2, wherein
the write error includes off-track, and
the controller is configured to
position the magnetic head based on the read servo data obtained by reading the servo data from each of the plurality of servo regions through which the magnetic head passes, and
determine, every time the servo data is read, whether the off-track has occurred based on the read servo data.

5. The magnetic disk device according to claim 3, wherein
the controller is configured to, in a case where it is determined that the off-track has occurred based on the servo data read from a first servo region that is one among the plurality of servo regions, determine that the off-track has occurred in each of two fifth servo regions adjacent to the first servo region among the plurality of first data regions.

6. The magnetic disk device according to claim 4, wherein
the controller is configured to, in a case where it is determined that the off-track has occurred based on the servo data read from a first servo region that is one among the plurality of servo regions, determine that the off-track has occurred in each of two fifth servo regions adjacent to the first servo region among the plurality of first data regions.

7. The magnetic disk device according to claim 1, further comprising a vibration sensor, wherein
the write error includes that a detection value by the vibration sensor exceeds a threshold value.

8. The magnetic disk device according to claim 1, wherein
the controller is configured to, in a case where the write error is detected in the second write operation to the second data region, execute again the second write operation on the second data region.

9. The magnetic disk device according to claim 2, wherein
the controller is configured to, in a case where the write error is detected in the second write operation to the second data region, execute again the second write operation on the second data region.

10. The magnetic disk device according to claim 3, wherein
the controller is configured to, in a case where the write error is detected in the second write operation to the second data region, execute again the second write operation on the second data region.

11. A method of controlling a magnetic disk device including a magnetic disk provided with a track, the track being provided with a data sector, the data sector including a plurality of servo regions in which servo data is written, and a plurality of first data regions, each of the plurality of first data region being arranged between two servo regions among the plurality of servo regions, the method comprising:
executing a first write operation of writing data sequentially to the plurality of first data regions using a magnetic head, and
executing, after the first write operation, a second write operation of retrying writing to a second data region in which a write error is detected among the plurality of first data regions, and not retrying writing to a third data region in which the write error is not detected among the plurality of first data regions.

12. The method according to claim 11, further comprising:
determining whether the write error has occurred during execution of the first write operation;
interrupting writing during the execution of the first write operation in a case where it is determined that the write error has occurred; and
restarting writing before the magnetic head reaches a fourth data region at a tail of the data sector among the plurality of first data regions in a case where the write error has been resolved before the magnetic head reaches the fourth data region after interrupting the writing.

13. The method according to claim 11, wherein
the write error includes off-track, and
the method further includes
positioning the magnetic head based on the read servo data obtained by reading the servo data from each of the plurality of servo regions through which the magnetic head passes, and
determining, every time the servo data is read, whether the off-track has occurred based on the read servo data.

14. The method according to claim 12, wherein
the write error includes off-track, and
the method further includes
positioning the magnetic head based on the read servo data obtained by reading the servo data from each of the plurality of servo regions through which the magnetic head passes, and
determining, every time the servo data is read, whether the off-track has occurred based on the read servo data.

15. The method according to claim 13, further comprising:
in a case where it is determined that the off-track has occurred based on the servo data read from a first servo region that is one among the plurality of servo regions, determining that the off-track has occurred in each of two fifth servo regions adjacent to the first servo region among the plurality of first data regions.

16. The method according to claim 14, further comprising:
in a case where it is determined that the off-track has occurred based on the servo data read from a first servo region that is one among the plurality of servo regions, determining that the off-track has occurred in each of two fifth servo regions adjacent to the first servo region among the plurality of first data regions.

17. The method according to claim 11, wherein
the magnetic disk device further includes a vibration sensor, and
the write error includes that a detection value by the vibration sensor exceeds a threshold value.

18. The method according to claim 11, further comprising:
in a case where the write error is detected in the second write operation to the second data region, executing again the second write operation on the second data region.

19. The method according to claim 12, further comprising:
in a case where the write error is detected in the second write operation to the second data region, executing again the second write operation on the second data region.

20. The method according to claim 13, further comprising:
in a case where the write error is detected in the second write operation to the second data region, executing again the second write operation on the second data region.
